(19) United States
(12) Patent Application Publication
(10) Pub. No.: US 2018/0101119 A1
(43) Pub. Date: Apr. 12, 2018

(54) MOTOR CONTROL DEVICE AND IMAGE FORMING APPARATUS

(71) Applicant: KYOCERA Document Solutions Inc., Osaka (JP)

(72) Inventor: Yuki YAMAGISHI, Osaka-shi (JP)

(73) Assignee: KYOCERA Document Solutions Inc., Osaka (JP)

(21) Appl. No.: 15/717,172

(22) Filed: Sep. 27, 2017

(30) Foreign Application Priority Data
Oct. 12, 2016 (JP) 2016-200853

(51) Int. Cl. G03G 15/00

(52) U.S. Cl. CPC G03G 15/6529; G03G 15/1615

(57) ABSTRACT

A motor control device includes a motor and a motor driver. The motor rotates a conveyance roller that conveys a sheet. The motor driver drives the motor on the basis of a control signal. The motor driver receives from the motor a rotation signal indicating a rotation amount of the motor and performs feedback control on the motor on the basis of the rotation signal and the control signal. The feedback control refers to controlling the motor to make the rotation amount indicated by the rotation signal match a rotation amount specified by the control signal. The motor driver stops the feedback control when determining that a rotation amount of the motor per unit time determined on the basis of the rotation signal has converged to a rotation amount per unit time specified by the control signal.

### INCORPORATION BY REFERENCE

The present application claims priority under 35 U.S.C. §119 to Japanese Patent Application No. 2016-200853, filed on Oct. 12, 2016. The contents of this application are incorporated herein by reference in their entirety.

### BACKGROUND

The present disclosure relates to a motor control device and an image forming apparatus.

There is a motor that performs positioning control under feedback control by a motor driver. The feedback control refers to driving the motor by the motor driver such that a rotation amount of the motor matches a rotation amount specified by a control signal.

For example, in a press machine, a position-speed controller outputs a position deviation signal by comparing a slide position signal (control signal) with a feedback signal indicating an actually detected slide position. On the basis of the position deviation signal, a driver section applies motor driving current to the motor to drive the motor.

### SUMMARY

A motor control device according to a first aspect of the present disclosure includes a motor and a driver. The motor rotates a conveyance roller that conveys a sheet. The driver drives the motor on the basis of a control signal. The driver receives from the motor a rotation signal indicating a rotation amount of the motor and performs feedback control on the motor on the basis of the rotation signal and the control signal. The feedback control refers to controlling the motor to make the rotation amount indicated by the rotation signal match a rotation amount specified by the control signal. The driver stops the feedback control when determining that a rotation amount of the motor per unit time determined on the basis of the rotation signal has converged to a rotation amount per unit time specified by the control signal.

An image forming apparatus according to a second aspect of the present disclosure includes the motor control device according to the first aspect of the present disclosure, the conveyance roller, and an image forming section. The image forming section forms an image on the sheet.

### BRIEF DESCRIPTION OF THE DRAWINGS

FIG. 1 is a diagram illustrating an image forming apparatus according to an embodiment of the present disclosure.

FIG. 2 is a diagram illustrating configuration of a motor control device according to an embodiment of the present disclosure.

FIG. 3 is a diagram illustrating a frequency of a control signal according to an embodiment of the present disclosure.

FIG. 4A is a diagram illustrating a waveform of a control signal and a waveform of a rotation signal according to an embodiment of the present disclosure.

FIG. 4B is a diagram illustrating a frequency of the control signal and a frequency of the rotation signal according to the embodiment of the present disclosure.

FIG. 4C is a diagram illustrating a detection signal of a sensor according to the embodiment of the present disclosure.

FIG. 4D is a diagram illustrating a difference between the number of control pulses and the number of rotation pulses according to the embodiment of the present disclosure.

FIG. 5 is a flowchart illustrating a motor control process performed by the motor control device according to an embodiment of the present disclosure.

### DETAILED DESCRIPTION

The following describes an embodiment of the present disclosure with reference to the drawings. However, the present disclosure is not limited to the embodiment described below. In the drawings, elements that are the same or substantially equivalent are labelled using the same reference signs and explanation thereof will not be repeated.

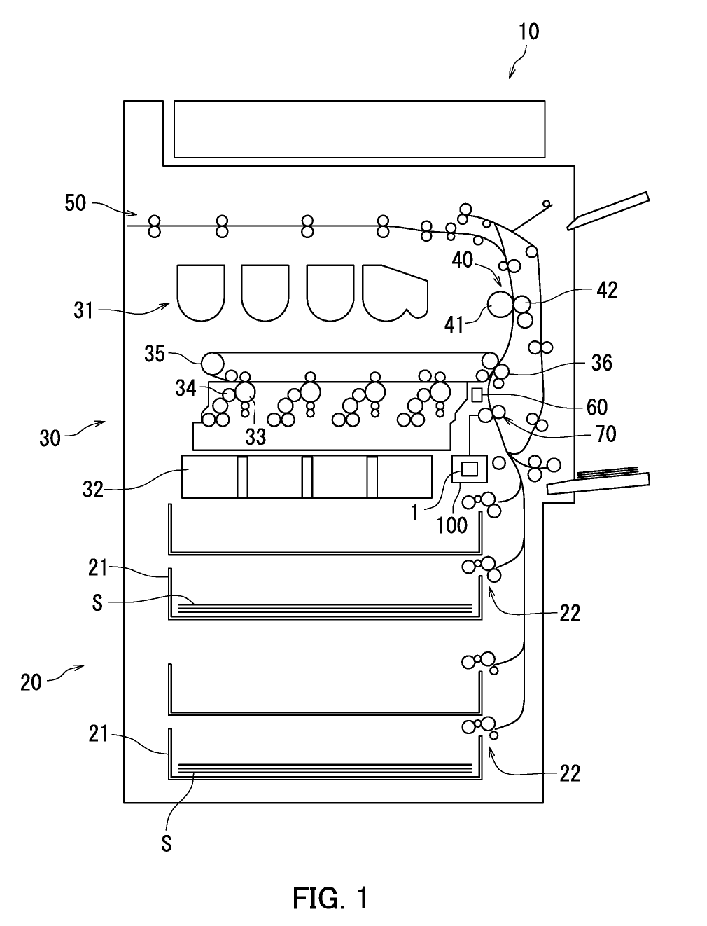

First, the following describes with reference to FIG. 1 an image forming apparatus including a motor control device. FIG. 1 illustrates the image forming apparatus. As illustrated in FIG. 1, an image forming apparatus 10 includes a motor control device 100, a feeding section 20, an image forming section 30, a fixing section 40, an ejection section 50, a sensor 60, and a conveyance roller 70. The motor control device 100 includes a controller 1 that controls operation of each part of the image forming apparatus 10. The controller 1 will be described further below.

The feeding section 20 includes feeding cassettes 21 and feeding rollers 22. The feeding cassettes 21 are each capable of accommodating plural sheets S. The feeding rollers 22 feed the sheets S accommodated in the feeding cassettes 21 to the conveyance roller 70 sheet by sheet. Note that the sheet S is an example of a recording medium.

The conveyance roller 70 conveys the sheet S. In the present embodiment, the conveyance roller 70 conveys the sheet S from the feeding section 20 to the image forming section 30. The conveyance roller 70 in the present embodiment is a registration roller. The conveyance roller 70 performs skew correction on the sheet S being conveyed. At this time, the conveyance roller 70 temporarily stops the sheet S being conveyed. After temporarily stopping the sheet S, the conveyance roller 70 forwards the sheet S to the image forming section 30 at an appropriate timing for image formation on the sheet S.

The image forming section 30 forms an image on the sheet S conveyed by the conveyance roller 70. The image forming section 30 includes a toner replenishment device 31, a light exposure device 32, a photosensitive drum 33, a development roller 34, an intermediate transfer belt 35, and a transfer roller 36.

The toner replenishment device 31 replenishes toner on the development roller 34. The light exposure device 32 irradiates the photosensitive drum 33 with laser light to form an electrostatic latent image. The development roller 34 supplies toner to the photosensitive drum 33 to develop the electrostatic latent image. Through the above, an image is formed on the photosensitive drum 33.

The image formed on the photosensitive drum 33 is transferred to the intermediate transfer belt 35. The conveyance roller 70 conveys the sheet S to the transfer roller 36. The image transferred to the intermediate transfer belt 35 is transferred to the sheet S by the transfer roller 36. The sheet S to which the image has been transferred is conveyed to the fixing section 40.

The fixing section 40 includes a heating member 41 and a pressure member 42. The fixing section 40 fixes the transferred image on the sheet S by applying heat and pressure to the sheet S by the heating member 41 and the pressure member 42. The ejection section 50 ejects the sheet S on which the image has been fixed to the outside of the main body of the apparatus.

The sensor 60 is located between the transfer roller 36 and the conveyance roller 70. The sensor 60 detects the sheet S. The sensor 60 generates a detection signal of the sheet S.

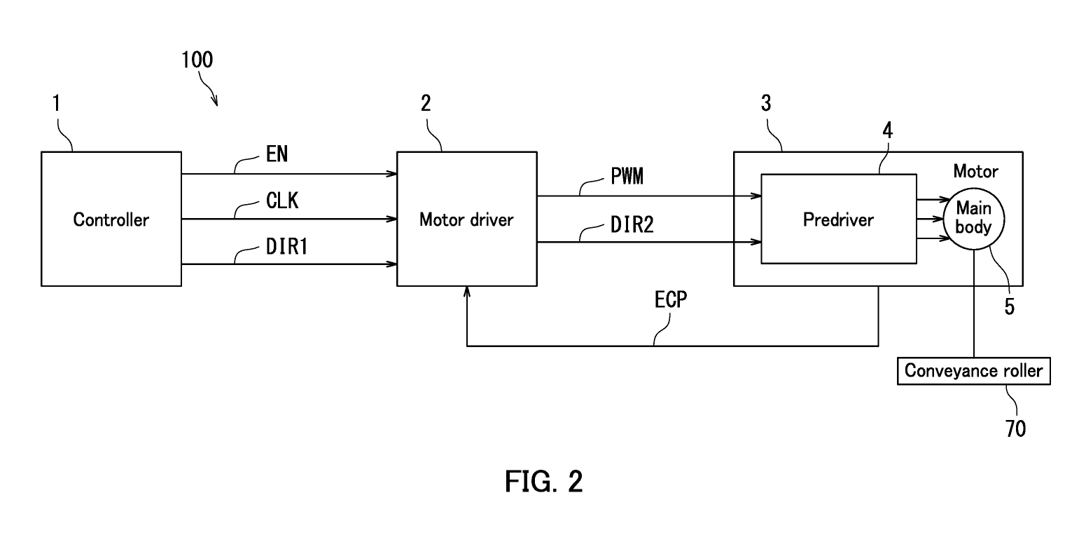

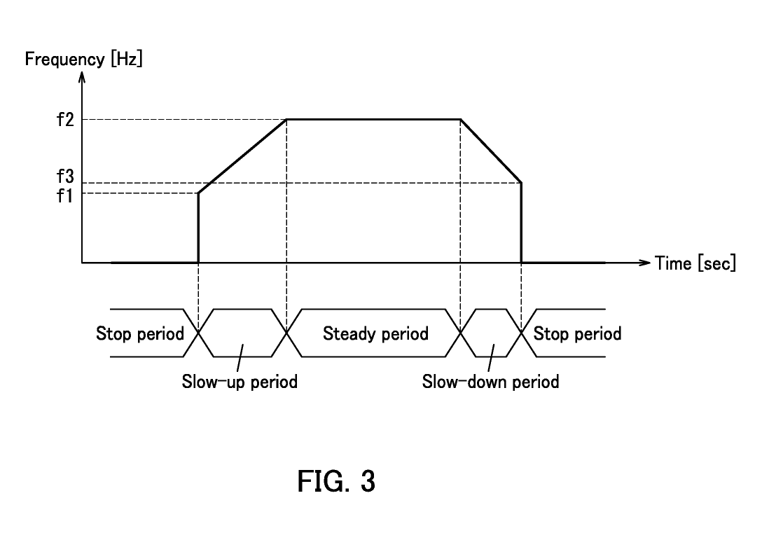

Next, the following describes with reference to FIGS. 2 and 3 the motor control device 100 according to a first embodiment. FIG. 2 is a diagram illustrating the motor control device 100. The motor control device 100 further includes a motor driver 2 as a driver, and a motor 3.

The controller 1 includes for example a central processing unit (CPU) or a micro processing unit (MPU). Also, the controller 1 includes storage such as a random access memory (RAM) device, a read only memory (ROM) device, and a hard disk drive (HDD).

The controller 1 generates an enable signal EN, a control signal UK, and a first rotation-direction instruction signal DIR1. The controller 1 supplies the enable signal EN, the control signal CLK, and the first rotation-direction instruction signal DIR1 to the motor driver 2.

The control signal CLK is a square wave alternating current signal with a fixed cycle for driving the motor 3. The control signal CLK is for example a clock signal. A rotation amount of the motor 3 and a rotation amount of the motor 3 per unit time are specified by the control signal CLK. The controller 1 supplies the control signal CLK. to the motor driver 2 during a period in which the motor 3 is driven. The following describes with reference to FIG. 3 details of the control signal CLK.

FIG. 3 illustrates a frequency of the control signal CLK. In FIG. 3, the vertical axis represents the frequency of the control signal CLK and the horizontal axis represents time. A stop period indicates a period in which the motor 3 is stopped by the control signal CLK. The stop period is for example a period in which the frequency of the control signal CLK is zero (Hz). Therefore, the controller 1 does not supply the control signal CLK to the motor driver 2 during the stop period.

A slow-up period indicates a period in which the frequency of the control signal CLK increases. When starting to supply the control signal CLK, the controller 1 initially sets the frequency of the control signal CLK at a first frequency f1. When the controller 1 starts to supply the control signal CLK to the motor driver 2, the motor 3 starts to be driven.

After starting to drive the motor 3 until making the frequency of the control signal CLK constant, the controller 1 gradually increases the frequency of the control signal CLK from the first frequency f1 to a second frequency f2. The second frequency f2 is a frequency for rotating the motor 3 at a target rotational speed. Therefore, after the motor 3 starts to be driven until the frequency of the control signal CLK. becomes constant, the rotational speed of the motor 3 gradually increases to the target rotational speed. Here, the rotational speed indicates the number of rotations of the motor 3 per unit time. Also, the motor 3 is controlled such that the rotational speed of the motor 3 increases as the frequency of the control signal CLK increases.

A steady period indicates a period in which the frequency of the control signal CLK is constant. During the period in which the frequency of the control signal CLK is constant, the rotational speed of the motor 3 has reached the target rotational speed. During the period in which the frequency of the control signal CLK is constant, the controller 1 maintains the frequency of the control signal UK. at the second frequency f2. The second frequency 12 is higher than the first frequency f1. Also, the rotational speed of the motor 3 corresponding to the second frequency f2 is higher than the rotational speed of the motor 3 corresponding to the first frequency f1.

A slow-down period indicates a period in which the frequency of the control signal CLK decreases. During the period in which the frequency of the control signal CLK decreases, the controller 1 gradually decreases the frequency of the control signal CLK from the second frequency f2 to a third frequency 13. The third frequency f3 is lower than the second frequency f2. Also, the rotational speed of the motor 3 corresponding to the third frequency f3 is lower than the rotational speed of the motor 3 corresponding to the second frequency f2. Therefore, until the motor 3 is stopped, the rotational speed of the motor 3 gradually decreases from the target rotational speed to the rotational speed corresponding to the third frequency f3.

Note that the first frequency f1, the second frequency f2, and the third frequency f3 are stored in the storage in advance. The first frequency f1 and the third frequency f3 may be the same or different from each other. In the present embodiment, the third frequency f3 is higher than the first frequency f1. However, the third frequency f3 may be lower than the first frequency f1. Further, the frequency of the control signal CLK may be represented by a voltage value through frequency voltage conversion.

The following further describes the motor control device 100 with reference to FIG. 2. The enable signal EN is a signal for giving the motor driver 2 instructions about whether or not to drive the motor 3. When the enable signal EN indicates to drive the motor 3, the motor driver 2 drives the motor 3. When the enable signal EN indicates not to rotate the motor 3, the motor driver 2 does not drive the motor 3 even when the control signal CLK is supplied from the controller 1.

For example, when the enable signal EN is at a High level, the enable signal EN indicates to drive the motor 3, and when the enable signal EN is at a Low level, the enable signal EN indicates not to rotate the motor 3. Note that the enable signal EN at a Low level may indicate to drive the motor 3. and the enable signal EN at a High level may indicate not to rotate the motor 3.

The first rotation-direction instruction signal DIR1 is a signal for giving instructions about a rotation direction of the motor 3. Similarly to the enable signal EN, the first rotation-direction instruction signal DIR1 at a High level or at a Low level specifies the rotation direction of the motor 3. For example, when rotating the motor 3 in a forward direction, the controller 1 supplies to the motor driver 2 the first rotation-direction instruction signal DIR1 at a High level. Also, when rotating the motor 3 in a reverse direction, the controller 1 supplies to the motor driver 2 the first rotation-direction instruction signal DIR1 at a Low level. Note that when rotating the motor 3 in the forward direction, the controller 1 may supply to the motor driver 2 the first rotation-direction instruction signal DIRT at a Low level, and when rotating the motor 3 in the reverse direction, the controller 1 may supply to the motor driver 2 the first rotation-direction instruction signal DIR1 at a High level.

The motor driver 2 drives the motor 3 by controlling the rotation amount of the motor 3 and the rotation amount of the motor 3 per unit time on the basis of the control signal CLK. Specifically, the motor driver 2 performs pulse width modulation (PWM) on the control signal CLK supplied from the controller 1. The pulse width modulation is a modulation method for modulating a pulse width by varying a duty cycle of the control signal CLK. The motor driver 2 supplies to the motor 3 a pulse-width-modulated signal PWM generated by the pulse width modulation of the control signal CLK.

Note that the motor driver 2 may generate a pulse-width-modulated signal PWM by performing the pulse width modulation on a specific signal stored in the motor driver 2 instead of the control signal CLK supplied from the controller 1. Alternatively, the motor driver 2 may generate a pulse-width-modulated signal PWM having a duty cycle similar to a duty cycle obtained by the pulse width modulation of the control signal CLK.

Also, the motor driver 2 generates a second rotation-direction instruction signal DIR2 on the basis of the first rotation-direction instruction signal DIR1 supplied from the controller 1. The motor driver 2 supplies the second rotation-direction instruction signal DIR2 to the motor 3. Specifically, when the first rotation-direction instruction signal DIR1 indicates forward rotation, the motor driver 2 generates the second rotation-direction instruction signal DIR2 such that the motor 3 rotates in the forward direction and supplies the second rotation-direction instruction signal DIR2 to the motor 3. By contrast, when the first rotation-direction instruction signal DIR1 indicates reverse rotation, the motor driver 2 generates the second rotation-direction instruction signal DIR2 such that the motor 3 rotates in the reverse direction and supplies the second rotation-direction instruction signal DIR2 to the motor 3.

The motor 3 rotates the conveyance roller 70. The motor 3 includes a predriver 4 and a main body 5. The predriver 4 is for example an inverter. The main body 5 is for example a brushless DC motor. The predriver 4 rotates the main body 5 on the basis of the pulse-width-modulated signal PWM and the second rotation-direction instruction signal DIR2 that are supplied from the motor driver 2. The main body 5 rotates the conveyance roller 70.

The motor 3 further includes for example an encoder. The encoder is for example attached to a shaft of the main body 5. The encoder detects a rotation amount of the rotating shaft of the motor 3 and generates a rotation signal ECP corresponding to a rotational displacement amount of the rotating shaft of the motor 3. That is, the rotation signal ECP indicates the rotation amount of the motor 3. The motor 3 supplies the generated rotation signal ECP to the motor driver 2.

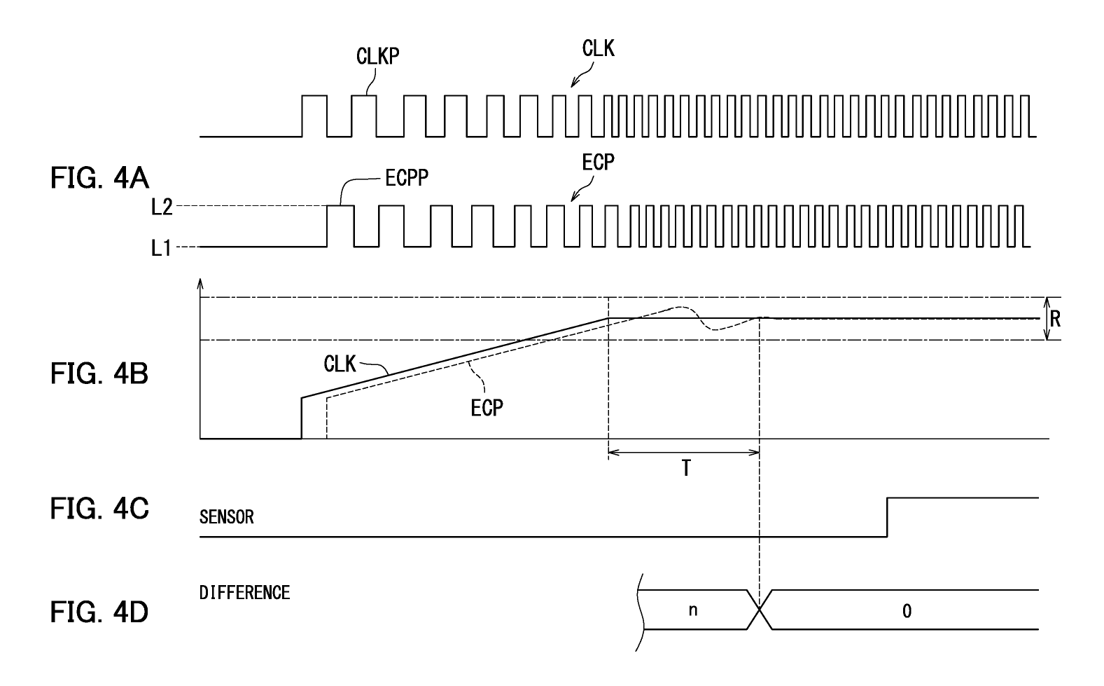

Next, the following describes with reference to FIGS. 2 to 4D feedback control performed by the motor driver 2. FIG. 4A illustrates a waveform of the control signal CLK and a waveform of the rotation signal ECP, Specifically, FIG. 4A illustrates a waveform of the control signal CLK input to the motor driver 2 during the slow-up period and the steady period and a waveform of the rotation signal ECP indicating the rotation amount of the motor 3 during the slow-up period and the steady period.

The control signal CLK includes a plurality of control pulses CLKP. The number of the control pulses CLKP indicates a rotation amount specified by the control signal CLK, The number of the control pulses CLKP per unit time indicates a rotation amount per unit time specified by the control signal CLK. In the following description, the rotation amount per unit time specified by the control signal CLK will be referred to as a specified rotational speed.

The rotation signal ECP includes a plurality of rotation pulses ECPP. The number of the rotation pulses ECPP indicates a rotation amount indicated by the rotation signal ECP. The number of the rotation pulses ECPP per unit time indicates a rotation amount of the motor 3 per unit time determined on the basis of the rotation signal ECP. In the following description, the rotation amount per unit time determined on the basis of the rotation signal ECP will be referred to as a measured rotational speed.

The motor driver 2 receives the rotation signal ECP from the motor 3. The motor driver 2 performs the feedback control on the motor 3 on the basis of the rotation signal ECP and the control signal CLK. The feedback control refers to controlling the motor 3 such that a rotation amount indicated by the rotation signal ECP matches a rotation amount specified by the control signal CLK. The following describes details of the feedback control.

Every time a rotation pulse ECPP shifts from a first level L1 to a second level L2, the motor driver 2 detects a difference between the number of the control pulses CLKP and the number of the rotation pulses ECPP. In the present embodiment, the first level L1 of the rotation pulse ECPP indicates a Low level of the rotation pulse ECPP, and the second level L2 of the rotation pulse ECPP indicates a High level of the rotation pulse ECPP. Note that the first level L1 of the rotation pulse ECPP may indicate a High level of the rotation pulse ECPP, and the second level L2 of the rotation pulse ECPP may indicate a Low level of the rotation pulse ECPP.

The motor driver 2 performs the feedback control on the basis of the detected difference. Specifically, the motor driver 2 performs the feedback control on the motor 3 such that the number of the rotation pulses ECPP matches the number of the control pulses CLKP. For example, the motor driver 2 performs the feedback control on the motor 3 such that the number of the rotation pulses ECPP matches the number of the control pulses CLKP during the slow-up period, the steady period, and the slow-down period. Alternatively, for example, the motor driver 2 performs the feedback control on the motor 3 such that the number of the rotation pulses ECPP matches the number of the control pulses CLKP during the steady period.

FIG. 4B illustrates a frequency of the control signal CLK and a frequency of the rotation signal ECP. In FIG. 4B, the vertical axis represents the frequency and the horizontal axis represents time. The frequency of the control signal CLK indicates the specified rotational speed for the motor 3. The frequency of the rotation signal ECP indicates the measured rotational speed of the motor 3. After the control signal CLK is supplied from the controller 1, the motor driver 2 determines whether or not the frequency of the control signal CLK has become constant. Note that the motor driver 2 may store therein a timing at which the frequency of the control signal CLK becomes constant. Alternatively, the motor driver 2 may detect a timing at which the frequency of the control signal CLK becomes constant on the basis of the control signal CLK supplied from the controller 1.

After the frequency of the control signal CLK has become constant, the motor driver 2 determines whether or not the measured rotational speed of the motor 3 has converged to the specified rotational speed for the motor 3. That is, the motor driver 2 determines whether or not the number of the rotation pulses ECPP per unit time has converged to the number of the control pulses CLKP per unit time.

Specifically, when the measured rotational speed of the motor 3 continuously indicates values within a predetermined range R for a predetermined period T, the motor driver 2 determines that the measured rotational speed of the motor 3 has converged to the specified rotational speed for the motor 3. The predetermined range R is a range determined on the basis of the specified rotational speed for the motor 3. For example, the predetermined range R ranges between ±1% of the specified rotational speed for the motor 3. The predetermined period T may be set to any value by a user. Note that the frequency of the control signal CLK and the frequency of the rotation signal ECP may each be represented by a voltage value through frequency voltage conversion.

FIG. 4C is a diagram illustrating a detection signal of the sensor 60. As illustrated in FIG. 4C, after the measured rotational speed of the motor 3 continuously indicates values within the predetermined range R for the predetermined period T after the specified rotational speed for the motor 3 becomes constant, the detection signal of the sensor 60 shifts from a Low level to a High level. That is, the sensor 60 detects the sheet S. Before the sensor 60 detects the sheet S, the motor driver 2. determines whether or not the measured rotational speed of the motor 3 has converged to the specified rotational speed for the motor 3.

FIG. 4D illustrates a difference n between the number of the control pulses CLKP and the number of the rotation pulses ECPP. When determining that the measured rotational speed of the motor 3 has converged to the specified rotational speed for the motor 3, the motor driver 2 forcibly makes the difference n zero. Then, the motor driver 2 stops the feedback control. That is, when determining that the number of the rotation pulses ECPP per unit time has converged to the number of the control pulses CLKP per unit time, the motor driver 2 stops the feedback control. Note that the motor control device 100 resumes the stopped feedback control when the image forming apparatus 10 conveys a sheet S after conveyance of another sheet S.

As described above with reference to FIGS. 1 to 4D, according to the present embodiment, the feedback control is stopped when it is determined that the measured rotational speed of the motor 3 has converged to the specified rotational speed for the motor 3. Therefore, the feedback control can be stopped as appropriate. For example, the feedback control can be stopped before transfer of an image to the sheet S. Therefore, it can be prevented that a conveyance speed of the sheet S changes at the time of transfer of the image to the sheet S. As a result, occurrence of defects such as elongation or contraction of the image at the time of transfer of the image to the sheet S can be prevented.

Also, according to the present embodiment, after the frequency of the control signal CLK becomes constant, it is determined whether or not the measured rotational speed of the motor 3 has converged to the specified rotational speed for the motor 3. Therefore, the feedback control is stopped after the frequency of the control signal CLK becomes constant. As a result, it can be prevented that the feedback is stopped before the motor 3 rotates at the target rotational speed. Consequently, it can be prevented that the rotational speed of the motor 3 does not reach the target rotational speed due to stopping of the feedback control.

Further, according to the present embodiment, when the measured rotational speed of the motor 3 continuously indicates values within the predetermined range R for the predetermined period T, it is determined that the measured rotational speed of the motor 3 has converged to the specified rotational speed for the motor 3. Therefore, the feedback control is not stopped when the measured rotational speed of the motor 3 indicates values within the predetermined range R temporarily, that is, for a period shorter than the predetermined period T. As a result, the feedback control can be stopped more accurately.

Further, according to the present embodiment, the feedback control is stopped when it is determined that the number of the rotation pulses ECPP per unit time has converged to the number of the control pulses CLKP per unit time. Therefore, the motor driver 2. can easily determine whether or not to stop the feedback control. As a result, a load of the process performed by the motor driver 2 can be reduced.

Further, according to the present embodiment, every time the rotation pulse shifts from the first level to the second level, the feedback control is performed on the basis of a detected difference between the number of the control pulses and the number of the rotation pulses. Therefore, the feedback control is performed continuously. As a result, the measured rotational speed of the motor 3 tends to converge to the specified rotational speed for the motor 3.

Further, according to the present embodiment, the conveyance roller 70 under control by the motor control device 100 conveys the sheet S to the transfer roller 36. Therefore, it can be prevented that a conveyance speed of the sheet S changes at the time of transfer of an image to the sheet S. As a result, occurrence of defects such as elongation or contraction of the image at the time of transfer of the image to the sheet S can be prevented.

Further, according to present embodiment, before the sensor 60 located between the transfer roller 36 and the conveyance roller 70 detects the sheet S, it is determined whether or not the measured rotational speed of the motor 3 has converged to the specified rotational speed for the motor 3. Therefore, no time for the feedback control is necessary at the time of positioning of the sheet S passed through the sensor 60.

Further, according to present embodiment, before the sensor 60 detects the sheet 5, it is determined whether or not the measured rotational speed of the motor 3 has converged to the specified rotational speed for the motor 3. Therefore, the feedback control can be stopped before the sensor 60 detects the sheet S. That is, the feedback control can be stopped before an image is transferred to the sheet S by the transfer roller 36. As a result, it can be prevented that a conveyance speed of the sheet S changes at the time of transfer of the image to the sheet S. Consequently, occurrence of defects such as elongation or contraction of the image at the time of transfer of the image to the sheet S can be prevented.

Note that a distance between the sensor 60 and the transfer roller 36 is fixed. Therefore, when the measured rotational speed of the motor 3 has converged to the specified rotational speed for the motor 3 before detection of the sheet S by the sensor 60, a period from the detection of the sheet S by the sensor 60 to arrival of the sheet S at the transfer roller 36 is constant even if there is a difference between a rotation amount of the motor 3 and a rotation amount specified by the control signal CLK. As a result, a timing of forwarding the sheet S to the transfer roller 36 can be easily adjusted.

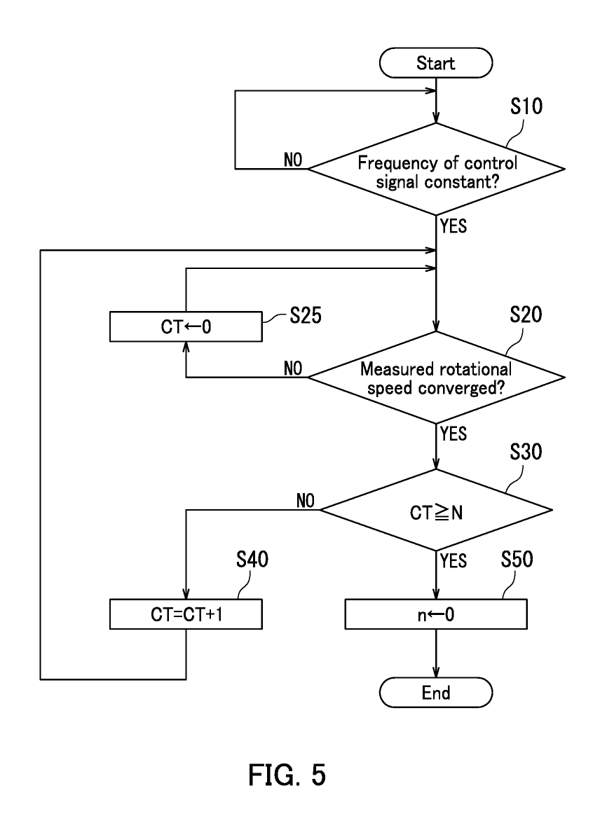

Next, the following describes with reference to FIGS. 1 to 5 a motor control process performed by the motor control device 100. FIG. 5 is a flowchart illustrating the motor control process performed by the motor control device 100. The motor control device 100 controls driving of the motor 3 by performing steps S10 to S50. At step S10, the motor driver 2 determines whether or not the frequency of the control signal CLK has become constant.

When the motor driver 2 determines “No” at step S10, the motor driver 2 determines again whether or not the frequency of the control signal CLK has become constant. That is, at step S10, the motor driver 2 continues determining whether or not the frequency of the control signal CLK has become constant until the frequency of the control signal CLK becomes constant. By contrast, when the motor driver 2 determines “Yes” at step S10, the process proceeds to step S20.

At step S20, the motor driver 2 determines whether or not the motor 3 has stabilized. That is, the motor driver 2 determines whether or not the measured rotational speed of the motor 3 has converged to the specified rotational speed for the motor 3.

When the motor driver 2 determines “No” at step S20, the process proceeds to step S25. At step S25, the motor driver 2 makes a count CT zero, and determines again whether or not the measured rotational speed of the motor 3 has converged to the specified rotational speed for the motor 3. That is, at step S20, the motor driver 2 continues determining whether or not the measured rotational speed of the motor 3 has converged to the specified rotational speed for the motor 3 until the measured rotational speed of the motor 3 converges to the specified rotational speed for the motor 3. The count CT will be described further below. By contrast, when the motor driver 2 determines “Yes” at step S20, the process proceeds to step S30.

At step S30, the motor driver 2 determines whether or not the count CT is N or greater. The count CT indicates the number of times the motor driver 2 has determined that the measured rotational speed of the motor 3 indicates values within the predetermined range R. When the motor driver 2 has determined N times or more that the measured rotational speed of the motor 3 indicates values within the predetermined range R, the motor driver 2 determines that the measured rotational speed of the motor 3 has continuously indicated values within the predetermined range R for the predetermined period T. The count CT is less than N until the measured rotational speed of the motor 3 continuously indicates values within the predetermined range R for the predetermined period T.

When the motor driver 2 determines “No” at step S30, the process proceeds to step S40. At step S40, the motor driver 2 increments the count CT, and the process proceeds to step S20. By contrast, when the motor driver 2 determines “Yes” at step S30, the motor driver 2 makes a difference n between the number of the control pulses CLKP and the number of the rotation pulses ECPP zero, and stops the feedback control. That is, when the measured rotational speed of the motor 3 has indicated values within the predetermined range R for the predetermined period T, the motor driver 2 stops the feedback control.

As described above with reference to FIGS. 1 to 5, according to the present embodiment, the feedback control is stopped when the motor driver 2 determines N times or more that the measured rotational speed of the motor 3 indicates values within the predetermined range R. Therefore, the feedback control is stopped in response to convergence of the measured rotational speed of the motor 3 to the specified rotational speed for the motor 3. As a result, the feedback control is stopped as appropriate.

Further, according to present embodiment, the count CT is made zero when the measured rotational speed of the motor 3 indicates a value outside the predetermined range R after the measured rotational speed of the motor 3 has indicated values within the predetermined range R temporarily, that is, for a period shorter than the predetermined period T. Therefore, the feedback control is not stopped when the measured rotational speed of the motor 3 indicates values within the predetermined range R temporarily, that is, for a period shorter than the predetermined period T. As a result, the feedback control can be stopped more accurately.

Through the above, the embodiment of the present disclosure has been described with reference to the drawings (FIGS. 1 to 5). However, the present disclosure is not limited to the above embodiment and is practicable in various manners within a scope not departing from the gist of the present disclosure (for example, as described below in (1)). The drawings schematically illustrate elements of configuration in order to facilitate understanding, and properties of elements of configuration illustrated in the drawings, such as thicknesses, lengths, and numbers thereof, may differ from actual properties thereof in order to facilitate preparation of the drawings. Also, properties of elements of configuration described in the above embodiment, such as shapes and dimensions thereof, are merely examples and are not intended as specific limitations. Various alterations may be made within a scope not substantially departing from effects of the present disclosure.

(1) As described with reference to FIG. 1, the motor control device 100 is included in the electrophotographic image forming apparatus 10. However, the motor control device 100 may be included in an inkjet image forming apparatus as long as the image forming apparatus includes the motor 3 that performs positioning control.

What is claimed is:

1. A motor control device comprising:
a motor configured to rotate a conveyance roller that conveys a sheet; and
a driver configured to drive the motor on the basis of a control signal, wherein
the driver receives from the motor a rotation signal indicating a rotation amount of the motor and performs feedback control on the motor on the basis of the rotation signal and the control signal,
the feedback control refers to controlling the motor to make the rotation amount indicated by the rotation signal match a rotation amount specified by the control signal, and
the driver stops the feedback control when determining that a rotation amount of the motor per unit time determined on the basis of the rotation signal has converged to a. rotation amount per unit time specified by the control signal.

2. The motor control device according to claim 1, wherein
after a frequency of the control signal becomes constant, the driver determines whether or not the rotation amount of the motor per unit time determined on the basis of the rotation signal has converged to the rotation amount per unit time specified by the control signal.

3. The motor control device according to claim 1, wherein
when the rotation amount of the motor per unit time determined on the basis of the rotation signal continuously indicates a value or values within a predetermined range for a predetermined period, the driver determines that the rotation amount of the motor per unit time determined on the basis of the rotation signal has converged to the rotation amount per unit time specified by the control signal, and
the predetermined range is determined on the basis of the rotation amount per unit time specified by the control signal.

4. The motor control device according to claim 1, wherein
the control signal includes a plurality of control pulses,
the number of the control pulses indicates the rotation amount specified by the control signal,
the number of the control pulses per unit time indicates the rotation amount per unit time specified by the control signal,
the rotation signal includes a plurality of rotation pulses,
the number of the rotation pulses indicates the rotation amount indicated by the rotation signal,
the number of the rotation pulses per unit time indicates the rotation amount of the motor per unit time determined on the basis of the rotation signal,
the driver
performs the feedback control on the motor to make the number of the rotation pulses match the number of the control pulses, and
stops the feedback control when determining that the number of the rotation pulses per unit time has converged to the number of the control pulses per unit time.

5. The motor control device according to claim 4, wherein
every time a rotation pulse of the rotation pulses shifts from a first level to a second level, the driver detects a difference between the number of the control pulses and the number of the rotation pulses, and performs the feedback control on the basis of the difference.

6. The motor control device according to claim 1, further comprising
a controller configured to generate a first rotation-direction instruction signal for giving instructions about a rotation direction of the motor, wherein
the controller supplies the first rotation-direction instruction signal to the driver,
the driver generates a second rotation-direction instruction signal on the basis of the first rotation-direction instruction signal,
the driver supplies the second rotation-direction instruction signal to the motor, and
the motor rotates the conveyance roller by rotating on the basis of the second rotation-direction instruction signal.

7. The motor control device according to claim 6, wherein
the controller generates the control signal and supplies the control signal to the driver during a period in which the motor is driven.

8. The motor control device according to claim 6, wherein
the controller generates an enable signal for giving the driver instructions about whether or not to drive the motor, and
when the control signal is supplied from the controller in a situation in which the enable signal indicates not to rotate the motor, the driver does not drive the motor.

9. An image forming apparatus comprising:
the motor control device according to claim 1;
the conveyance roller; and
an image forming section configured to form an image on the sheet.

10. The image forming apparatus according to claim 9, wherein
the image forming section includes a transfer roller that transfers the image to the sheet, and
the conveyance roller conveys the sheet to the transfer roller.

11. The image forming apparatus according to claim 10, further comprising
a sensor located between the transfer roller and the conveyance roller and configured to detect the sheet, wherein
before the sensor detects the sheet, the driver determines whether or not the rotation amount of the motor per unit time determined on the basis of the rotation signal has converged to the rotation amount per unit time specified by the control signal.
